(19) United States
(12) Patent Application Publication
(10) Pub. No.: US 2013/0287121 A1
(43) Pub. Date: Oct. 31, 2013

(54) METHOD AND APPARATUS FOR PARSING BITSTREAM, AND GENERIC PARSING APPARATUS

(71) Applicants: Electronics and Telecommunications Research Institute, (US); IUCF-HYU (Industry-University Cooperation Foundation Hanyang University), (US)

(72) Inventors: Seung Wook LEE, Daejeon (KR); Jin Sung CHOI, Daejeon (KR); Bon Ki KOO, Daejeon (KR); Euee Sun JANG, Seoul (KR); Hyun Kyu KIM, Seoul (KR); So Won KIM, Seoul (KR)

(73) Assignees: IUCF-HYU (Industry-University Cooperation Foundation Hanyang University), Seoul (KR); Electronics and Telecommunications Research Institute, Daejeon (KR)

(21) Appl. No.: 13/871,902

(22) Filed: Apr. 26, 2013

(30) Foreign Application Priority Data
Apr. 26, 2012 (KR) 10-2012-0044089
Mar. 6, 2013 (KR) 10-2013-0023738

(51) Int. Cl. H04N 7/26

(52) U.S. Cl. CPC H04N 19/00903
USPC 375/240.26

(57) ABSTRACT

A method and apparatus for parsing a bitstream that parses a bitstream by reconfiguring a parser during a run-time is disclosed. The method for parsing the bitstream may include reading bitstream syntax information for reconfiguring a parser, determining whether the bitstream syntax information is valid, reconfiguring a pre-defined parser, based on the bitstream syntax information when the bitstream syntax information is determined to be valid, and parsing the bitstream inputted, using the reconfigured parser.

### CROSS-REFERENCE TO RELATED APPLICATIONS

This application claims the priority benefit of Korean Patent Application No. 10-2012-0044089, filed on Apr. 26, 2012, and Korean Patent Application No. 10-2013-0023738, filed on Mar. 6, 2013, in the Korean Intellectual Property Office, the disclosures of which are incorporated herein by reference.

### BACKGROUND

1. Field of the Invention

The present invention relates to a framework for a reconfigurable codec, and more particularly, to a method and apparatus for parsing a bitstream that parses a bitstream inputted.

2. Description of the Related Art

In general, a moving image may be converted to a form of a bitstream through an encoder. Here, the bitstream may be stored based on an encoding type that satisfies constraint conditions of the encoder.

A Moving Picture Experts Group (MPEG) format may require a syntax and semantics as the constraint conditions of the bitstream. Here, the syntax may represent a structure, a form, and a length, and may represent a sequential order in which data is represented. In particular, the syntax may represent grammar that performs encoding and decoding, and defines a sequential order of elements, a respective length of the elements, data format, and the like.

A framework of a reconfigurable codec, currently being used as a standard in an MPEG format, may generate a bistream syntax description (BSD) that describes a syntax structure of the bitstream through a reconfigurable video coding-bitstream syntax description (RVC-BSDL) language defined by ISO/IEC 23001-4. The RVC-BSDL and Flavor languages may focus on a generation of a source code, in association with a method for generating a parser.

In a case of a conventional syntax parser designed in a built-in scheme, an implementation of a parser has terminated at a design stage. Furthermore, a method for generating a parser dynamically may not exist in reconfigurable multimedia coding (RMC), currently being used as an MPEG standard. Accordingly, there is a need for a parser description language that generates a parser dynamically during a run-time and a method for generating a parser dynamically for efficient parsing of a bitstream.

### SUMMARY

An aspect of the present invention provides a method for parsing a bitstream, the method including reading bitstream syntax information for reconfiguring a parser, determining whether the bitstream syntax information is valid, reconfiguring a pre-defined parser, based on the bitstream syntax information when the bitstream syntax information is determined to be valid, and parsing a bitstream input using the reconfigured parser.

The reconfiguring may include configuring an input port and an output port of the pre-defined parser, based on the interface information, setting a standby state for executing an external function, based on the plugin function information, and loading the control information to control the pre-defined parser.

The determining of whether the bitstream syntax information is valid may include determining whether a grammatical error is present in the bitstream syntax information, and determining whether a functional error associated with an interface and an external function is present in the bitstream syntax information.

Another aspect of the present invention also provides an apparatus for parsing a bitstream, the apparatus including a reading unit to read bitstream syntax information for reconfiguring a parser, a validity determining unit to determine whether the bitstream syntax information is valid, a parser reconfiguring unit to reconfigure a pre-defined parser, based on the bitstream syntax information when the bitstream syntax information is determined to be valid, and a bitstream parsing unit to parse a bitstream input, using the reconfigured parser.

Still another aspect of the present invention also provides a generic parsing apparatus, including a bitstream syntax information analyzing unit to divide bitstream syntax m information into control information, plugin function information, and interface information, through analyzing the bitstream syntax information for reconfiguring a parser, a control unit to parse a bitstream input, based on a control flow indicated in the control information, and an interface unit to configure an input port and an output port, based on the interface information.

The generic parsing apparatus may further include an external function calling unit to call an external function for performing a predetermined function, based on the plugin function information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an overall operation of a bitstream decoding system according to an embodiment of the present invention;

FIG. 2 is a diagram illustrating a detailed configuration of an apparatus for parsing a bitstream according to an embodiment of the present invention;

FIG. 3 is a diagram illustrating a detailed configuration of a generic parsing apparatus according to an embodiment of the present invention;

FIG. 4 is a diagram illustrating an operation of a generic parsing apparatus according to an embodiment of the present invention;

FIG. 5 is a diagram illustrating a structure of an extensible mark-up language (XML) of an XML-based parser description language according to an embodiment of the present invention;

FIG. 6 is a flowchart illustrating an operation of a method for parsing a bitstream according to an embodiment of the present invention;

FIG. 7 is a flowchart illustrating a detailed operation of determining a validity of bitstream syntax information according to an embodiment of the present invention;

FIG. 8 is a flowchart illustrating a detailed operation of reconfiguring a parser according to an embodiment of the present invention; and

FIG. 9 is a flowchart illustrating a process of executing a reconfigured parser according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

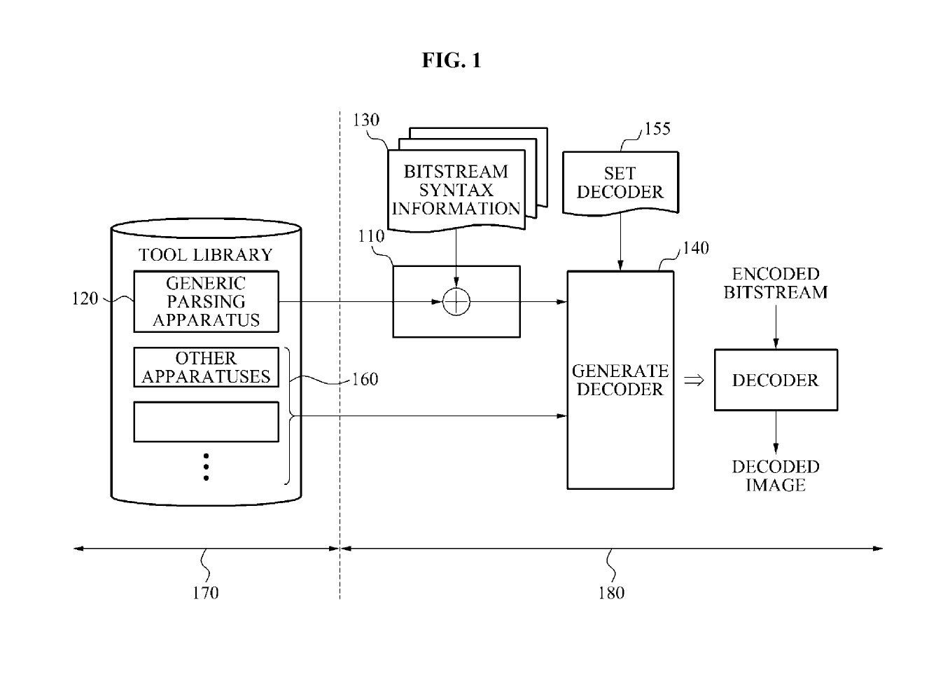

FIG. 1 is a diagram illustrating an overall operation of a bitstream decoding system according to an embodiment of the present invention.

Referring to FIG. 1, an operation of the bitstream decoding system may be described through being divided into a design section 170 and a run-time section 180.

In the design section 170, a generic parsing apparatus 120 and other apparatuses 160 for decoding a bitstream may be pre-defined. For example, the generic parsing apparatus 120 may refer to a bitstream parser that is reconfigurable or sets an operation scheme, and may be pre-defined by a tool library.

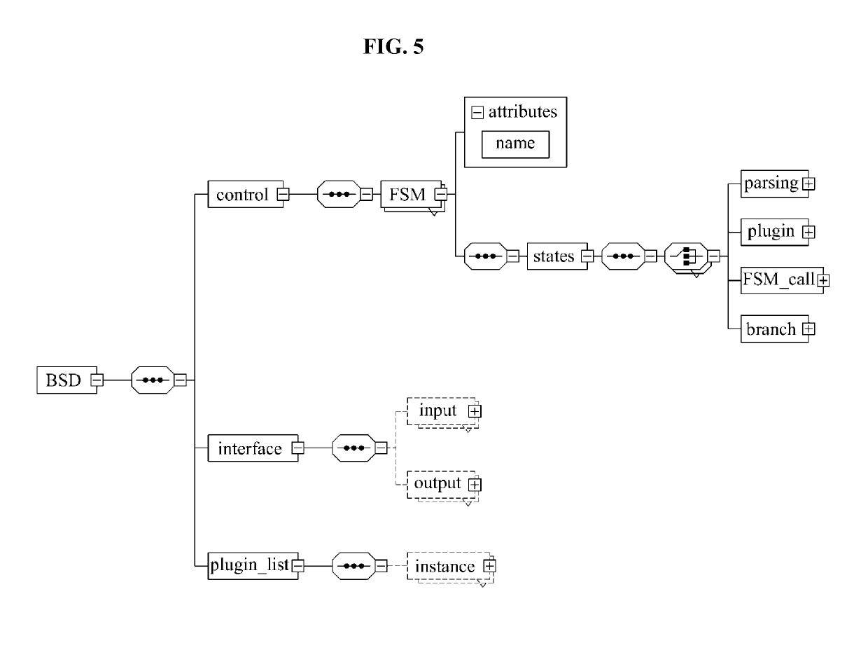

In the run-time section 180, an apparatus for parsing a bitsream 110 may reconfigure the generic parsing apparatus 120, based on bitsream syntax information 130 for reconfiguring a parser. For example, the bitstream syntax information 130 may be written in an extensible mark-up language (XML)-based syntax. Detailed descriptions of the bitstream syntax information will be described later with reference FIG. 5.

The apparatus for parsing the bitstream 110 may divide the bitstream syntax information 130 into control information, plugin function information, and interface information. The apparatus for parsing the bitstream 110 may set an input port and an output port of the generic parsing apparatus 120, based on the interface information and load an external function for performing a predetermined function, based on the plugin function information. The apparatus for parsing the bitstream 110 may compile a finite state machine (FSM) structure and translate content into an executable form, based on a control flow included in the control information. The apparatus for parsing the bitstream 110 may parse a bitstream, based on the control flow. The apparatus for parsing the bitstream 110 may parse a bitstream efficiently by configuring a bitstream parser dynamically in a framework of a reusable codec.

Subsequent to setting a decoder in operation 155, a decoder may be generated in operation 140, based on the generic parsing apparatus 120 reconfigured and the other apparatuses 160 for decoding the bitstream. The decoder may output an image decoded through inputting an encoded bitstream.

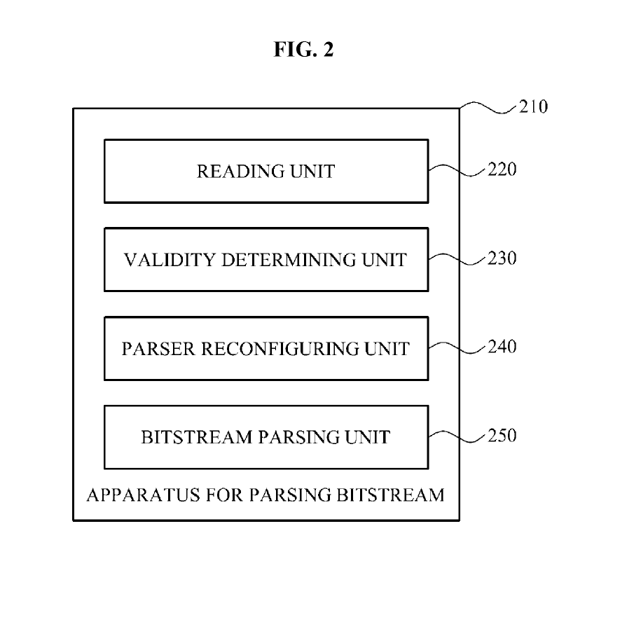

FIG. 2 is a diagram illustrating a detailed configuration of an apparatus 210 for parsing a bitstream according to an embodiment of the present invention.

Referring to FIG. 2, the apparatus 210 for parsing the bitstream may include a reading unit 220, a validity determining unit 230, a parser reconfiguring unit 240, and a bitstream parsing unit 250.

The reading unit 220 may read bitstream syntax information for reconfiguring a parser. In this instance, the bitstream syntax information may include control information, plugin function information, and interface information.

The control information may include information associated with a control flow of a parser that parses a bitstream inputted. For example, the control information may define at least one of a parsing state that represents a method for extracting information from the bitstream inputted, an external function call state to be used for calling an external function, an FSM call state to be used for calling an FSM, and a branch state for jumping onto another state based on a condition.

The plugin function information may include external function information for performing a predetermined external function. For example, the plugin function information may include parameter information associated with a codec, and an external function may be parameterized by a value dependent on a codec.

The interface information may include a definition of an input port and an output port of a parser. In this instance, a bitstream may be inputted through the input port, and a semantically decoded result may be outputted through the output port. For example, an outputted result may be used as a token of reconfigurable multimedia coding (RMC). The interface information may include a list of a total of the input port and the output port associated with the parser.

The validity determining unit 230 may determine a validity of the bitstream syntax information to prevent an unexpected error. The validity determining unit 230 may determine whether a pre-defined parser is to be reconfigured, by determining the validity of the bitstream syntax information.

More particularly, the validity determining unit 230 may determine whether a grammatical error and a functional error are present in the bitstream syntax information.

The validity determining unit 230 may verify the grammatical error of the bitstream syntax information, using XML examination tools based on an XML schema when the bitstream syntax information is written based on an XML. The validity determining unit 230 may verify a description grammar with respect to a parser configuration as well as an XML grammar.

The validity determining unit 230 may further determine whether the functional error is present when the grammatical error is absent in the bitstream syntax information. The validity determining unit 230 may determine whether operations of parsing the bitstream is performed properly by verifying the functional error.

The validity determining unit 230 may perform a functional examination of a parser interface, based on the interface information included in the bitstream syntax information. For example, the validity determining unit 230 may perform a functional examination of an interface by comparing a parser interface declaration and an actual input port and an output port currently being connected.

The validity determining unit 230 may perform a functional examination of an external function, based on the plugin function information included in the bitstream syntax information. The validity determining unit 230 may perform a functional examination of the plugin function by comparing an external function list and plugin functions being connected to a current parser.

The parser reconfiguring unit 240 may reconfigure a pre-defined parser, based on the bitstream syntax information when the bitstream syntax information is valid. At least one of the input port and the output port of the pre-defined parser may be determined variably, based on the bitstream syntax information. The parser may be pre-defined at a design stage, and the parser reconfiguring unit 240 may newly generate a parser most appropriate for bitstream parsing, through reconfiguring the parser pre-defined at the design stage.

The parser reconfiguring unit 240 may reconfigure the pre-defined parser, based on the control information, the pluglin function information, and the interface information extracted from the bitstream syntax information. More particularly, the parser reconfiguring unit 240 may configure the input port and the output port of the pre-defined parser, based on the interface information. For example, the parser reconfiguring unit 240 may connect the input port and the output port of the pre-defined parser to a module network of an RMC framework, based on the interface information.

The parser reconfiguring unit 240 may set a standby state for executing an external function, based on the plugin function information. For example, the parser reconfiguring unit 240 may configure a parser pre-defined to execute a complex operation such as entropy decoding, and the like, using a pre-defined external function. The parser reconfiguring unit 240 may prepare plugin function instances in the pre-defined parser, and prepare the plugin function instances to be in a state of being called by the control unit. The parser reconfiguring unit 240 may initialize the plugin function instances by applying parameters represented in the bitstream syntax information to the plugin function instances.

The parser reconfiguring unit 240 may load control information to control the pre-defined parser when the standby state for executing the external function is set based on the plugin function information. The parser reconfiguring unit 240 may read the control flow included in the control information, and initiate compiling of an FSM structure. The FSM structure may be compiled during a run-time, and translated into an immediately executable form.

The bitstream parsing unit 250 may parse a bitstream inputted, using the reconfigured parser. The bitstream parsing unit 250 may control the parser reconfigured to parse the bitstream in which the reconfigured parser is inputted when the parser reconfiguring unit 240 reconfigures the pre-defined parser, based on the bitstream syntax information subsequent to the reading unit 220 and the validity determining unit 230.

The bitstream parsing unit 250 may control an operation of the reconfigured parser, based on a type of a plurality of states in the control flow. The bitstream parsing unit 250 may control the reconfigured parser, such that a process of parsing the bitstream is performed continuously until the control flow is terminated or the bitstream inputted is terminated. The bitstream parsing unit 250 may control the parser reconfigured to call the plugin function to use an external function required for parsing of the bitstream in the process of parsing.

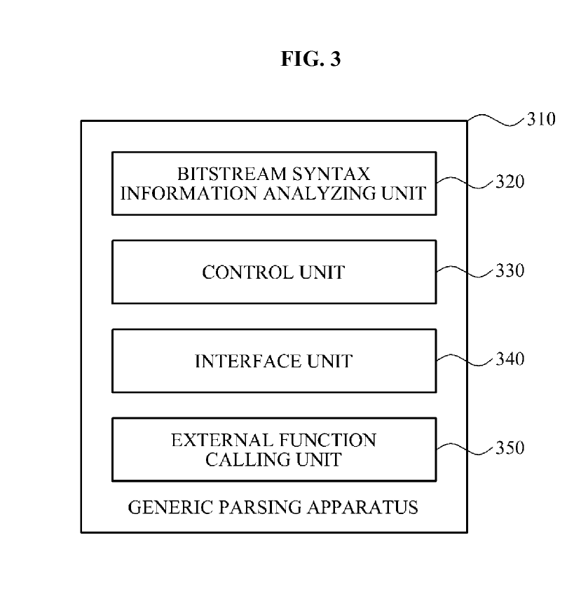

FIG. 3 is a diagram illustrating a detailed configuration of a generic parsing apparatus 310 according to an embodiment of the present invention.

Referring to FIG. 3, the generic parsing apparatus 310 may include a bitstream syntax information analyzing unit 320, a control unit 330, and an interface unit 340. The generic parsing apparatus 310 may further include an external function call unit 350.

The bitstream syntax information analyzing unit 320 may analyze bitstream syntax information for reconfiguring a parser. The bitstream syntax information may include control information associated with a control flow of a parser, plugin function information associated with external function information for performing a predetermined function outside a parser, and interface information associated with an input/output port of a parser.

The bitstream syntax information analyzing unit 320 may divide the bitstream syntax information into the control information, the plugin information, and the interface information.

The control unit 330 may reconfigure the generic parsing apparatus 310 based on the bitstream syntax information, and control calling of an interface and an external function, based on the control information. Also, the control unit 330 may perform a process of parsing of a bitstream inputted, based on the control flow represented in the control information when a reconfiguration of the generic parsing apparatus 310 is completed.

The interface unit 340 may configure the input port and the output port, based on the interface information, and connect the input port and the output port to another network. For example, the interface unit 340 may connect the input port and the output port to a module network of an RMC framework.

The external function calling unit 350 may call an external function that performs a predetermined function, based on the plugin function information. The external function may refer to a function of a prototype loaded along with a predetermined parameter set by the control flow represented in the control information. The external function calling unit 350 may prepare plugin function instances to be in a state of being called by the control unit 330.

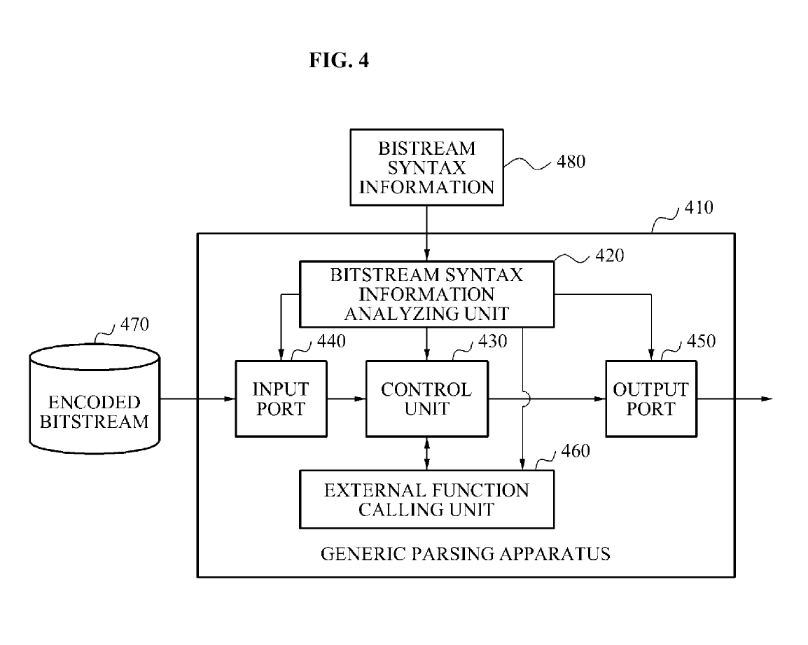

FIG. 4 is a diagram illustrating an operation of a generic parsing apparatus 410 according to an embodiment of the present invention.

Referring to FIG. 4, the generic parsing apparatus 410 reconfigurable during a run-time is illustrated.

A bitstream syntax information analyzing unit 420 may receive bitstream syntax information 480 to divide the bitstream syntax information 480 into control information, external function information, and interface information. The bitstream syntax information analyzing unit 420 may provide the divided control information, the external function information, and the interface information to a control unit 430, an external function calling unit 460, and an interface unit (not shown), respectively.

The bitstream syntax information analyzing unit 420 may initiate a process of reconfiguring the generic parsing apparatus 410 to be performed when dividing the bitstream syntax information 480. The bitstream syntax information analyzing unit 420 may use XML parser libraries, such as MS-XML, Xerces, TinyXML, and the like, to divide the bitstream syntax information 480.

The interface unit may configure and set an input port 440 and an output port 450 of the generic parsing apparatus 410. The generic parsing apparatus 410 may communicate with another network such as an RMC framework through the input port 440 and the output port 450. An encoded bitstream 470 may be inputted through the input port 440, and parsed or decoded data may be outputted through the output port 450. The input port 440 and the output port 450 of the generic parsing apparatus 410 may be determined variably based on the interface information included in the bitstream syntax information 480. Accordingly, the input port 440 and the output port 450 may be controlled dynamically during a run-time.

The control unit 430 may reconfigure the generic parsing apparatus 410, based on the control information received from the bitstream syntax information analyzing unit 420, and control calling of an interface and an external function, based on the control information. The control unit 430 may perform a process of parsing of the encoded bitstream 470, based on a control flow represented in the control information when a reconfiguration of the generic parsing apparatus 410 is completed.

For example, the control unit 430 may refer to a script engine that executes a control flow description included in the bitstream syntax information 480. The script engine may be based on a run-time compiling method for a script language such as a run-time interpreter, a just-in-time (JIT) compiler, a virtual machine, and the like.

The external function calling unit 460 may manage a plugin function for calling external functions to perform a complex parsing function. The external function calling unit 460 may call an external function for performing a predetermined function, based on plugin function information. The external function calling unit 460 may prepare plugin function instances to be in a state of being called by the control unit 430. The plugin function may be generated by a plugin function declaration, and be loaded along with a predetermined parameter set by the control flow included in the control information.

FIG. 5 is a diagram illustrating a structure of an XML of an XML-based parser description language according to an embodiment of the present invention.

An apparatus for parsing a bitstream may use the XML-based parser description language to reconfigure a pre-defined parser during a run-time. The apparatus for parsing the bitstream may generate a parser in a framework dynamically, based on a description of a parser defined in eXternal Subroutine-program design language (XS-PDL). XS-PDL may refer to a model describing an FSM. The FSM may be modeled to be so as to be performed by abstract minimum information to describe a process of parsing. The FSM may be implemented readily and reused in various other platforms when the FSM is modeled by minimum information.

An XML may be used, in MPEG RMC, as a language writing a decoder description, for example, a functional unit network language (FNL). XS-PDL may be written based on the XML to achieve a compatibility with an MPEG RMC decoder description. Transitively, the apparatus for parsing the bitstream may perform a validity test of a document, using an existing XML tool. XS-PDL may comply with a grammar of W3C XML, and an overall structure is illustrated in FIG. 5. A bitstream syntax description (BSD) that configures the bitstream syntax information may be generated through XS-PDL.

The BSD may include a control flow description, a parser interface declaration, and an external function declaration.

Elements of the control flow description used in XS-PDL may be represented by Table 1.

TABLE 1

| Element | Attributes/Children/Notes | |
|---|---|---|
| <control> | A top-level tag of an XS-PDL control flow description | |
| | Children: <FSM>* | |
| <FSM> | A tag declaring an FSM | |
| | name = “FSM_name” | The identifier of an FSM. |
| | Children: <states> | |
| <states> | A bundle tag for declaring a state | |
| | Children: (<parsing> \| <plugin> \| <FSM_call> \| <branch>)* | |
| <parsing> | A parsing state declaration tag | |
| | name = “state_name” | A state name (also used as a variable name) |
| | bits = “expression” | A bit length to be read from a bitstream |
| | source = “input_port_name” | An input port name to be used |
| | bytealign = “(true \| false)” | A bytealign option |
| | peek = “(true \| false)” | A look-ahead parsing option |
| | expected = “expression” | An expected value. An error occurs when a read |
| | | value is unidentical to the expected value. |
| | value = “expression” | A default value |
| | final = “(true \| false)” | A presence of a final state in which an FSM is |
| | | terminated. |
| | Children: {<process>, <output>} | |
| <plugin> | External function call state declaration tag | |
| | name = “state_name” | Identical to parsing |
| | callee = “ plugin_instance_name” | An external function name to be called |
| | Children: (<parameters> \| <process> \| <output>) | |
| | Note: <parameters> | |
| <FSM_call> | An FSM call state. | |
| | name = “state_name” | Identical to parsing |
| | callee = “FSM_name” | An FSM name to be called |
| | Children: {<process> , <output>*} | |
| <branch> | A branch state based on a conditional jump among states.. | |
| | name = “state_name” | Identical to parsing |
| | condition = “expression” | A branch condition. When a value is determined |
| | | to be true, that is, when the value is determined |
| | | not to be zero, a branch occurs. |
| | next = “operation_name” | A subsequent state name when a branch occurs. |
| | Children: <process> | |
| <process> | Description of an additional decoding operation. | |
| | Children: (<operation> \| <if>)* | |
| <output> | Description of a port output of a parsed data. | |
| | dest = “output_port_name” | An output port name |
| | value = “expression” | A value to be outputted |
| <operation> | An operation for additional decoding process. | |
| | name = “operation_name” | A name of an operation process |
| | target = “variable” | A variable to be updated |
| | value = “expression” | A value to be updated (calculation equation) |
| <if> | A flow control statement within additional decoding process using a conditional jump among | |
| | operations. | |
| | name = “operation_name” | Identical to <operation> |
| | condition = “expression” | A branch condition. When a value is determined |
| | | to be true, that is, the value is determined not to |
| | | be zero, a branch occurs. |
| | next = “operation_name” | A name of a subsequent operation process when a |
| | | branch occurs. |

The control flow of bitstream parsing may be described by the FSM in XS-PDL. The control flow description may be configured by at least one FSM, including a sub-FSM. A respective FSM, or <FSM>, may be represented as one of a parsing state, an external function call state, an FSM call state, and a branch state.

The plurality of states may have a “name” attribute to be used as an identifier, and a method for parsing a bitstream to be performed based on a type of codec may be defined. A sequential order in which the FSM is performed may follow a sequential order described in a control flow description unit, and an initial state of the FSM may refer to a first state represented in the FSM.

The parsing state, or <parsing>, may provide information associated with how information of a predetermined length of a bitstream inputted is parsed. The information to be provided may be described by declaring the parsing state as shown in Table 1. A method for extracting information from a bitstream may be defined by “bits”, “bytealign”, and “peek” attributes. Information of a bit length to be parsed from an input bit may be defined by the “bits” attribute in a form of an unsigned integer. Byte alignment information may be defined by the “bytealign” attribute. A parsing state declaration may define a look-ahead parsing process, using the “peek” attribute. The bitstream inputted may be defined by a “source” attribute value. The “source” attribute value, being an option, may be used in a case in which at least two multi-bitstreams are required to be processed during a process of bitstream parsing. A syntax element of a bitstream may need to be set as a predetermined value, and a validity of the syntax element may be verified, using a value defined in an “expected” attribute.

The parsing state may be used for defining data failing to be parsed in the bitstream, and may be defined by a “value” attribute. Also, the parsing state may be used for defining a final state of a current FSM. For example, the FSM may stop subsequent to a current state being terminated, when a “final” attribute value is “true”.

A parsed value may be stored and processed as a general variable in a remaining parsing process. The parsing state or the external function call state may automatically generate a variable with an identical name, respectively. Accordingly, reading a bit from a bitstream without declaring a variable may be possible. When two states have an identical name, a single variable may be used.

An incidental decoding process of the parsing state may be added through a <process> element. The incidental decoding process may include a mathematical calculation, a logic calculation, a binary variable calculation, and the like. The <process> element may include a plurality of <operation> elements and a plurality of <if> elements. The plurality of <operation> elements and the plurality of <if> elements may be labeled by a “name” attribute. The plurality of <operation> elements may perform a function of assigning a value, a “target” attribute may represent a value being assigned, or updated, and a “value” attribute may represent a value to be updated. A mathematical representation in a form of a simple C language may be used for the “value” attribute. The <if> attribute may be used for describing a branch statement based on a condition. A value in a “condition” attribute may be described in the same manner as the “value” attribute defined in <operation>. When a value in the “condition” attribute is “true”, an action to be performed next may be an action labeled by a “next” attribute. Otherwise, the action to be performed next may be performed according to a sequential order.

The apparatus for parsing the bitstream may provide a decoded value to a reconfigurable codec network. An output in a plurality of parsing states may be described by an <output> element, and an output port may be set by a “dest” attribute. The set output port may be defined in the parser interface declaration, or <interface>. A value of the parser interface declaration, or <interface>, may be described by the “value” attribute, and may be a fixed value or a variable.

The external function call state, or <plugin>, may be used for calling an external function. A function to be called may be described by a “callee” attribute, and one of values included in a list, or <plugin_list>, defining the external function may be set. A parameter with respect to calling the external function may be described by a <parameters> element. The <parameters> element may have several other <parameters> elements as children. A plurality of <parameters> elements may have the “name” attribute as an identifier, and may have the “value” attribute describing an actual value of the parameter. The external function call state may set an additional decoding operation.

At least one FSM may appear in the control flow description, and an individual FSM may be called by an FSM call state, or <FSM_call>. The called FSM may be set by the “callee” attribute, and a “callee” value may refer to an FSM defined in the currently control flow description. The FSM call state may have a description with respect to the additional decoding operation.

The branch state, or <branch>, may be used for moving to another state, based on a condition. The branch state may include a “condition” attribute representing a condition and a “next” attribute setting a location to move to. The condition of a branch state may be described in a syntax identical to the “value” attribute of an additional decoding description unit. The branch state may perform the additional decoding operation described in the <process> attribute, and a result of performing of the additional decoding operation may be used for the condition of the branch state.

Bitstream parsing defined for the plurality of states may follow a precedence level defined in Table 2. Table 2 illustrates a precedence level for processing for a plurality of tags.

TABLE 2

| | | |
|---|---|---|
| Precedence | | |
| Level | Element | Attribute |

(1) Parsing State

| | | |
|---|---|---|
| 1 | <parsing> | source |
| 2 | <parsing> | peek |
| 3 | <parsing> | bytealign |
| 4 | <parsing> | bits |
| 5 | <parsing> | value |
| 6 | <parsing> | expected |
| 7 | <parsing> | name |
| 8 | <operation> | value |
| 9 | <operation> | target |
| 10 | <if> | condition |
| 11 | <if> | next |
| 12 | <output> | value |
| 13 | <output> | dest |
| 14 | <parsing> | final |

(2) External Function Call State

| | | |
|---|---|---|
| 1 | <parameter> | name |
| 2 | <parameter> | value |
| 3 | <plugin> | callee |
| 4 | <plugin> | name |
| 5 | <operation> | value |
| 6 | <operation> | target |
| 7 | <if> | condition |
| 8 | <if> | next |
| 9 | <output> | value |
| 10 | <output> | dest |

(3) FSM Call State

| | | |
|---|---|---|
| 1 | <FSM_call> | <callee> |
| 2 | <operation> | value |
| 3 | <operation> | target |
| 4 | <if> | condition |
| 5 | <if> | next |
| 6 | <output> | value |
| 7 | <output> | dest |

(4) Branch State

| | | |
|---|---|---|
| 1 | <operation> | value |
| 2 | <operation> | target |
| 3 | <if> | condition |
| 4 | <if> | next |
| 5 | <branch> | condition |
| 6 | <branch> | next |

In general, reading of a bitstream, calling of an external function, and calling of an FSM may take precedence over the additional decoding operation and transmitting a result to an output port. A condition used for the branch state may be executed subsequent to performing the additional decoding operation to update a value of a conditional statement. The “final” attribute terminating an FSM currently being performed may operate subsequent to the additional decoding operation and a total of results being transmitted to the output port.

The external function used for the control flow description may be defined in an external function call declaration syntax, or <plugin_list>. Table 3 may represent elements of the external function call declaration syntax.

TABLE 3

| Element | Attributes/Children/Notes | |
|---|---|---|
| <plugin_list> | A top-level tag of XS-PDL external function declaration | |
| | Children: <instance>* | |
| <instance> | An external function instance declaration tag | |
| | name = “plugin_instance_name” | An instance name |
| | prototype = “plugin_prototype_name” | An external function prototype name to be |
| | | used |
| | Children: <parameters> | |
| <parameters> | A parameter declaration bundle tag | |
| | Children: <parameter>* | |
| <parameter> | An individual parameter declaration tag | |
| | name = “plugin_parameter_name” | A parameter name |
| | value = “(value \| array_value)” | A parameter value (a fixed value or an array |
| | | type) |

A prototype with respect to an external function including an identifier character string available in the apparatus for parsing the bitstream is required to be valid. A prototype function may be referenced by an <instance> element. A single prototype may be referenced to a plurality of prototypes by another parameter. A plurality of external call functions may be generated as an instance including a parameter by the <parameters> element.

An input port and output port interface may be declared in a BSD. Table 4 illustrates elements of an interface declaration syntax.

TABLE 4

| Element | Attributes/Children/Notes | |
|---|---|---|
| <interface> | A top-level tag of a parser interface declaration in XS-PDL | |
| | Children: (<input> \| <output>)* | |
| <input> | An input port declaration tag | |
| | name = “input_port_name” | A port name |
| | token_type = “token_type” | A token type |
| <output> | An output port declaration tag | |
| | name = “output_port_name” | A port name |
| | token_type = “token_type” | A token type |

An input port and an output port may be defined as an <input> element and an <output> element, respectively. The input port and output port elements may have an identical attribute. A respective port name may be defined by the “name” attribute, and a respective data type of the ports may be defined by a “token_type” attribute. The “token_type” attribute may be an option, and follow a form defined in an existing MPEG RMC standard.

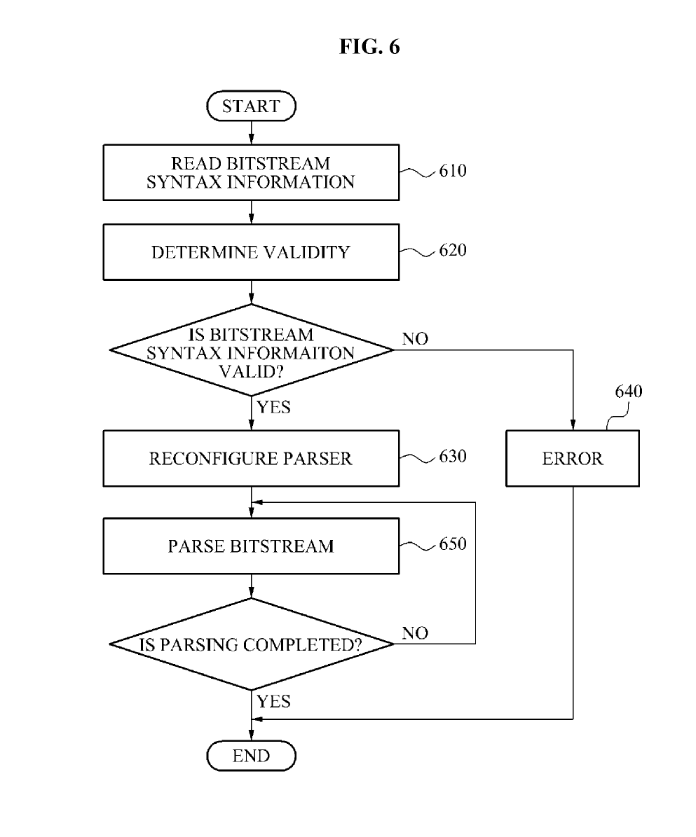

FIG. 6 is a flowchart illustrating an operation of a method for parsing a bitstream according to an embodiment of the present invention.

In operation 610, an apparatus for parsing a bitstream may read bitstream syntax information for reconfiguring a parser. The bitstream syntax information may include control information associated with a control flow of a parser, plugin function information associated with external function information for performing a predetermined function outside the parser, and interface information associated with an input/output port of the parser.

In operation 620, the apparatus for parsing the bitstream may determine a validity of the bitstream syntax information to prevent an unexpected error. For example, the apparatus for parsing the bitstream may determine whether a grammatical error and a functional error are present in the bitstream syntax information. The apparatus for parsing the bitstream may determine whether the bistream syntax information is valid to determine whether a pre-defined parser is to be reconfigured. The apparatus for parsing the bitstream may terminate an operation without reconfiguring a parser when an error is determined to be present in the bitstream syntax information in operation 640.

In operation 630, the apparatus for parsing the bitstream may reconfigure a pre-defined parser, based on the bitstream syntax information when the bitstream syntax information is determined to be valid. The apparatus for parsing the bitstream may reconfigure the pre-defined parser, based on the control information, the plugin function information, and the interface information extracted from the bitstream syntax information. A parser may be pre-defined at a design stage, and the apparatus for parsing the bitstream may newly generate a parser most appropriate for bitstream parsing in a run-time section by reconfiguring the parser defined at the design stage.

In operation 650, the apparatus for parsing the bitstream may parse a bitstream inputted, using the reconfigured parser. More particularly, the apparatus for parsing the bitstream may control the reconfigured parser, such that the reconfigured parser may parse the bitstream inputted. The apparatus for parsing the bitstream may control an operation of the reconfigured parser, based on the control information, the plugin function information, and the interface information extracted from the bitstream syntax information. The apparatus for parsing the bistream may control the reconfigured parser, such that a process of parsing a bitstream may be performed continuously based on a control flow included in the control information until the parsing is completed through the control flow being terminated or the bitstream inputted being terminated. Also the apparatus for parsing the bitstream may control the parser reconfigured to call the plugin function in order to use an external function required for parsing of the bitstream during the process of parsing.

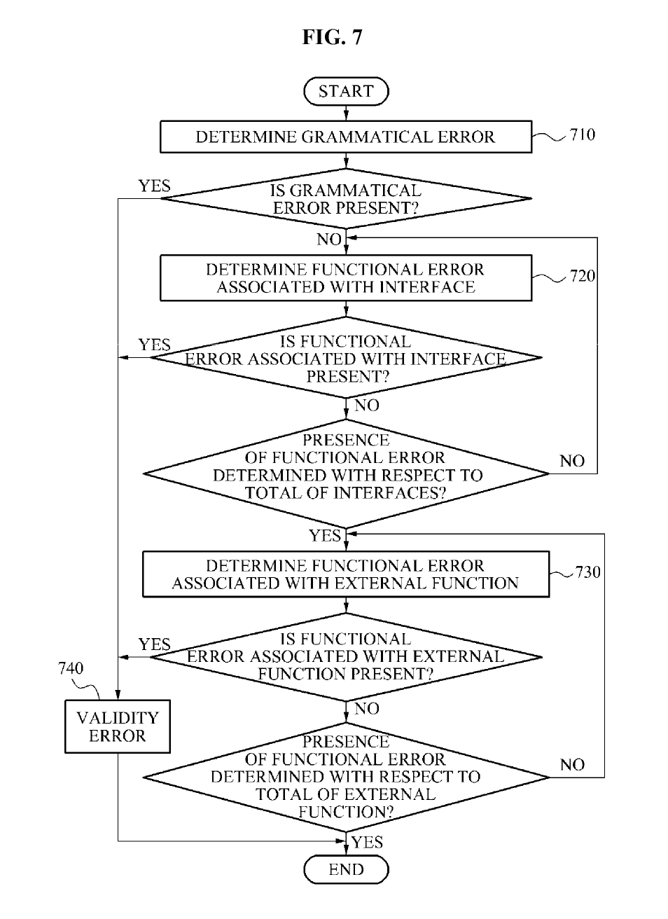

FIG. 7 is a flowchart illustrating a detailed operation of determining a validity of bitstream syntax information according to an embodiment of the present invention.

In operation 710, an apparatus for parsing a bitstream may determine whether a grammatical error is present in the bistream syntax information. The apparatus for parsing the bitstream may verify the grammatical error of the bitstream syntax information, using XML examination tools, based on an XML schema when the bitstream syntax information is written based on an XML. The apparatus for parsing the bitstream may verify grammar of a description with respect to a parser configuration, as well as XML grammar. The apparatus for parsing the bitstream may terminate an operation without progressing onto a next step when a validity error is determined to be present in operation 740 through a presence of the grammatical error in the bitstream syntax information.

In operation 720, the apparatus for parsing the bitstream may determine whether a functional error is present in the bistream syntax information when the grammatical error is absent in the bitstream syntax information. The apparatus for parsing the bitstream may perform a functional verification of a parser interface, based on interface information included in the bitstream syntax information. For example, the apparatus for parsing the bitstream may perform the functional verification, by comparing a parser interface declaration and an actual input port and an output port currently being connected. The apparatus for parsing the bitstream may determine whether the functional error is present with respect to a total of interfaces, and when the functional error is determined to be present in the bitstream syntax information, the validity error may be determined to be present in operation 740, and may terminate an operation.

In operation 730, the apparatus for parsing the bitstream may perform the functional verification with respect to an external function, based on the plugin function information included in the bitstream syntax information. The apparatus for parsing the bitstream may perform the functional verification of a plugin function by comparing an external function list and plugin functions currently being connected to a parser. The apparatus for parsing the bitstream may determine whether the functional error is present with respect to a total of external functions, and when the functional error is determined to be present in the bitstream syntax information, the validity error is determined to be present in operation 740, and may terminate an operation.

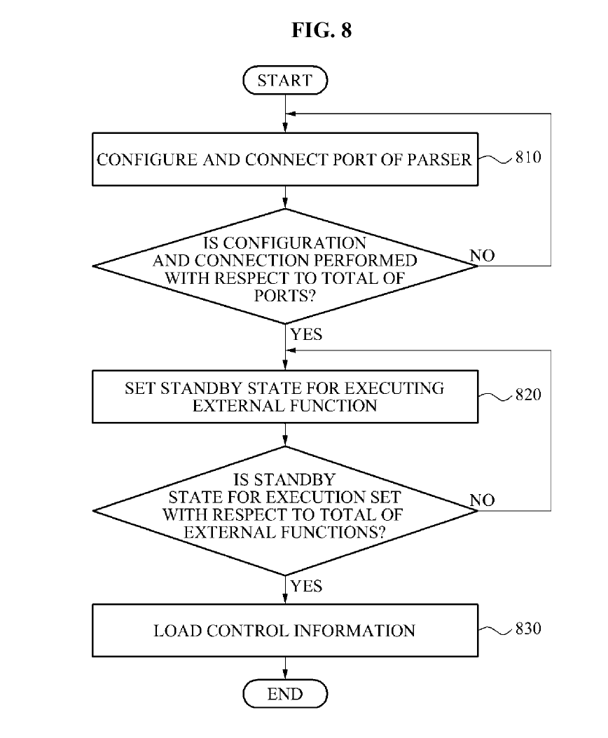

FIG. 8 is a flowchart illustrating a detailed operation of reconfiguring a parser according to an embodiment of the present invention.

In operation 810, an apparatus for parsing a bitstream may configure and connect an input port and an output port of a pre-defined parser, based on bitstream syntax information. For example, the apparatus for parsing the bitstream may set the input port and output port of the pre-defined parser, based on a parser interface declaration included in the bitstream syntax information. The apparatus for parsing the bitstream may connect the input port and the output port to a module network of an RMC framework.

In operation 820, the apparatus for parsing the bitstream may set a standby state for executing an external function, based on plugin function information. The apparatus for parsing the bitstream may configure the pre-defined parser, such that a complex operation such as entropy decoding, and the like, may be performed using a pre-defined external function. The apparatus for parsing the bitstream may prepare plugin function instances in the pre-defined parser, and prepare the plugin function instances to be in a state being called.

In operation 830, the apparatus for parsing the bitstream may load control information to control the pre-defined parser when the standby state for executing an external function is set, based on the plugin function information. The apparatus for parsing the bitstream may read a control flow included in the control information, and initiate compiling of an FSM structure. The FSM structure may be compiled during a run-time, and be translated into an immediately executable form.

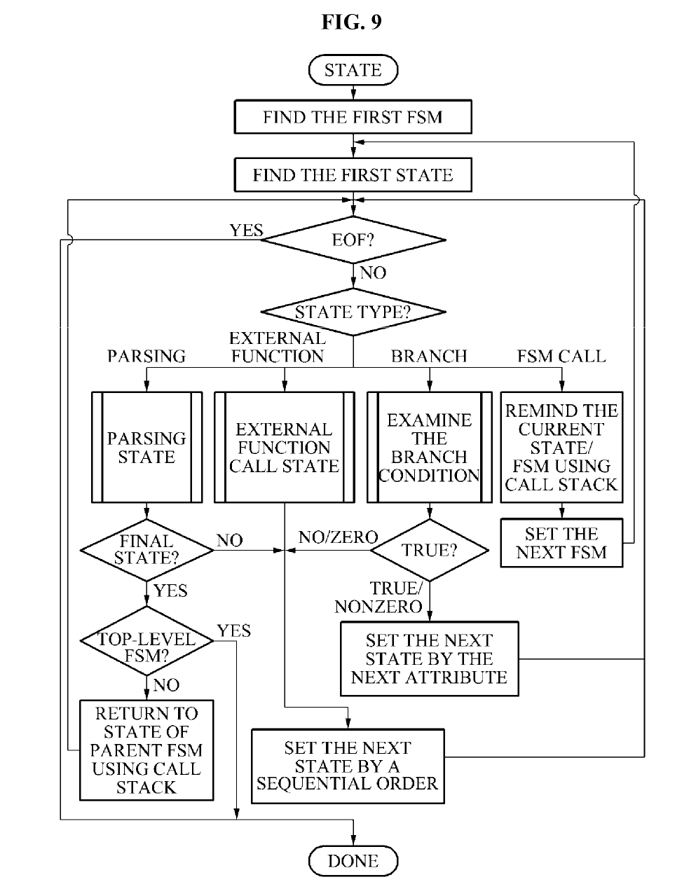

FIG. 9 is a flowchart illustrating a process of executing a reconfigured parser according to an embodiment of the present invention.

FIG. 9 illustrates a detailed operation of an apparatus for parsing a bitstream, subsequent to a parser being reconfigured. The apparatus for parsing the bitstream may parse a bitstream, based on a plurality of state types in a control flow. For example, the apparatus for parsing the bitstream may perform an operation, based on the plurality of state types, by determining whether the state type is a parsing state, an external function call state, an FSM call state, and a branch state.

An operation based on the plurality of state types may be performed continuously until a value representing an end of file (EOF) appears. A process of parsing a bitstream inputted may continue until the control flow is terminated or the bitstream inputted is terminated.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for parsing a bitstream, the method comprising:
reading bitstream syntax information for reconfiguring a parser;
determining whether the bitstream syntax information is valid;
reconfiguring a pre-defined parser, based on the bitstream syntax information when the bitstream syntax information is determined to be valid; and
parsing a bitstream input using the reconfigured parser.

2. The method of claim 1, wherein the reconfiguring comprises:
extracting at least one of control information, plugin function information, and interface information from the bitstream syntax information.

3. The method of claim 2, wherein the control information comprises at least one of:
a parsing state representing a method for extracting information from the bitstream input, an external function call state to be used when calling an external function, a finite state machine (FSM) call state to be used for calling an FSM, and a branch state for jumping onto another state based on a condition.

4. The method of claim 2, wherein the plugin function information comprises:
external function information for performing a predetermined function outside the parser.

5. The method of claim 2, wherein the interface information comprises:
a definition of an input port and an output port.

6. The method of claim 2, wherein the reconfiguring comprises:
configuring an input port and an output port of the pre-defined parser, based on the interface information;
setting a standby state for executing an external function, based on the plugin function information; and
loading the control information to control the pre-defined parser.

7. The method of claim 1, wherein the determining of whether the bitstream syntax information is valid comprises:
determining whether a grammatical error is present in the bitstream syntax information; and
determining whether a functional error associated with an interface and an external function is present in the bitstream syntax information.

8. The method of claim 1, wherein at least one of an input port and an output port of the pre-defined parser is determined variably, based on the bitstream syntax information.

9. The method of claim 1, wherein the bitstream syntax information is written in an extensible mark-up language (XML)-based syntax.

10. An apparatus for parsing a bitstream, the apparatus comprising:
a reading unit to read bitstream syntax information for reconfiguring a parser;
a validity determining unit to determine whether the bitstream syntax information is valid;
a parser reconfiguring unit to reconfigure a pre-defined parser, based on the bitstream syntax information when the bitstream syntax information is determined to be valid; and
a bitstream parsing unit to parse a bitstream input, using the reconfigured parser.

11. The apparatus of claim 10, wherein the parser reconfiguring unit reconfigures a pre-defined parser based on at least one of control information, plugin function information, and interface information extracted from the bitstream syntax information.

12. The apparatus of claim 11, wherein the parser reconfiguring unit configures an input port and an output port of the pre-defined parser, based on the interface information, and load the control information to control the pre-defined parser, subsequent to setting a standby state for executing an external function, based on the plugin function information.

13. The apparatus of claim 11, wherein the control information comprises at least one of:
a parsing state representing a method for extracting information from the bitstream input, an external function call state to be used for calling an external function, a finite state machine (FSM) call state to be used for calling an FSM, and a branch state for jumping onto another state based on a condition.

14. The apparatus of claim 11, wherein the plugin function information comprises:
external function information to perform a predetermined function outside the parser.

15. The apparatus of claim 11, wherein the interface information comprises a definition of an input port and an output port.

16. The apparatus of claim 10, wherein the validity determining unit determines whether a grammatical error and a functional error are present in the bitstream syntax information.

17. The apparatus of claim 10, wherein at least one of an input port and an output port of the pre-defined parser are determined variably, based on the bitstream syntax information.

18. A generic parsing apparatus, comprising:
a bitstream syntax information analyzing unit to divide bitstream syntax information into control information, plugin function information, and interface information, through analyzing the bitstream syntax information for reconfiguring a parser;
a control unit to parse a bitstream input, based on a control flow indicated in the control information; and
an interface unit to configure an input port and an output port, based on the interface information.

19. The generic parsing apparatus of claim 18, further comprising:
an external function calling unit to call an external function for performing a predetermined function, based on the plugin function information.

20. The generic parsing apparatus of claim 19, wherein the external function is a prototype function to be loaded along with a predetermined parameter set by a control flow indicated in the control information.
